(19) United States
(12) Patent Application Publication
(10) Pub. No.: US 2007/0036146 A1
(43) Pub. Date: Feb. 15, 2007

(54) Analyzing and resolving internet service problems

(75) Inventors: James Adkins, Canton, GA (US); Stephen Cersosimo, Buford, GA (US)

Correspondence Address: MERCHANT & GOULD PC, P.O. BOX 2903, MINNEAPOLIS, MN, 55402-0903, US

(73) Assignee: BellSouth Intellectual Property Corporation

(21) Appl. No.: 11/314,938

(22) Filed: Dec. 21, 2005

Related U.S. Application Data
(60) Provisional application No. 60/707,031, filed on Aug. 10, 2005.

(51) Int. Cl. H04L 12/66

(52) U.S. Cl. 370/352; 370/242

(57) ABSTRACT

Methods, systems, and computer program products analyze and resolve Internet service problems. A method involves receiving via a user interface consumer data associated with a request for Internet service problem analysis and resolution, triggering a query to retrieve additional data, and querying one or more systems to fulfill the request. The method further involves retrieving from the systems, information associated with fulfilling the request, identifying the Internet Service problem, and rendering in real time the Internet service problem via the user interface. Still further the method involves rendering and enabling a command to fix the Internet service problem in response to identifying the Internet service problem, receiving a selection of the command to fix the Internet service problem, fixing the Internet service problem in substantially real time, and rendering notice of the fix and disabling the command to fix the Internet service problem.

### CROSS-REFERENCE TO RELATED APPLICATIONS

This utility patent application claims the benefit under 35 United States Code § 119(e) of U.S. Provisional Patent Application No. 60/707,031 filed on Aug. 10, 2005 which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention generally relates to resolving problems for Internet customers and, more particularly, relates to methods, computer-readable mediums, and systems for analyzing and resolving customer problems with Internet service.

### BACKGROUND

When Internet customers experience problems with their Internet service, they typically want the problem resolved quickly. Uninformed customer service agents supporting an Internet customer with not enough information not only do not know what to ask the customer, they do not know how to interpret what is seen when looking at support systems for information. This translates into inefficient customer service. Some conventional systems use a utility, called a Ping, to troubleshoot Internet connections by determining whether a specific IP address is accessible. It works by sending a packet to the specified address and waiting for a reply. These conventional IP Ping tools ping the customer from a remote network. For instance, an agent may be on a totally different network than the customer. The agents, while on their own local LAN in their offices, try to ping a customer on a different network and receive inaccurate information.

With conventional systems the only way to get a fix is to open a ticket and hang up an initial call without resolution. The ticket will be issued to a ticketing system to be worked on, probably, the next day. A customer call back occurs when the ticketed problem has been resolved and submitted to the helpdesk. In some cases, an abuse team can cut a customer off for Internet service abuse. Then, that customer would call in to find out what went wrong and they would be forwarded from the agent to the abuse team. The abuse team would explain what went wrong and fill out a form to correct the problem in order to re-enable the customer account.

Accordingly there is an unaddressed need in the industry to address the aforementioned and other deficiencies and inadequacies.

### BRIEF DESCRIPTION OF THE DRAWINGS

FIG. 1 is a schematic diagram illustrating aspects of a networked operating environment utilized in an illustrative embodiment of the invention;

FIG. 2 illustrates computing system architecture for an external helpdesk personal computer utilized in an illustrative embodiment of the invention;

FIG. 3 illustrates computing system architecture for a data server computer utilized in an illustrative embodiment of the invention;

FIG. 4 illustrates an interface display utilized in an illustrative embodiment of the invention;

FIG. 5 illustrates an operational flow performed in analyzing an Internet service problem according to an illustrative embodiment of the invention;

FIG. 6 illustrates an operational flow performed in resolving an Internet service problem according to an illustrative embodiment of the invention; and

FIG. 7 illustrates an operational flow performed in analyzing and resolving Internet service problems according to an illustrative embodiment of the invention.

### DETAILED DESCRIPTION

As described briefly above, embodiments of the present invention provide methods, systems, and computer-readable mediums for analyzing and resolving Internet service problems. In the following detailed description, references are made to accompanying drawings that form a part hereof, and in which are shown by way of illustration specific embodiments or examples. These illustrative embodiments may be combined, other embodiments may be utilized, and structural changes may be made without departing from the spirit and scope of the present invention. The following detailed description is, therefore, not to be taken in a limiting sense, and the scope of the present invention is defined by the appended claims and their equivalents.

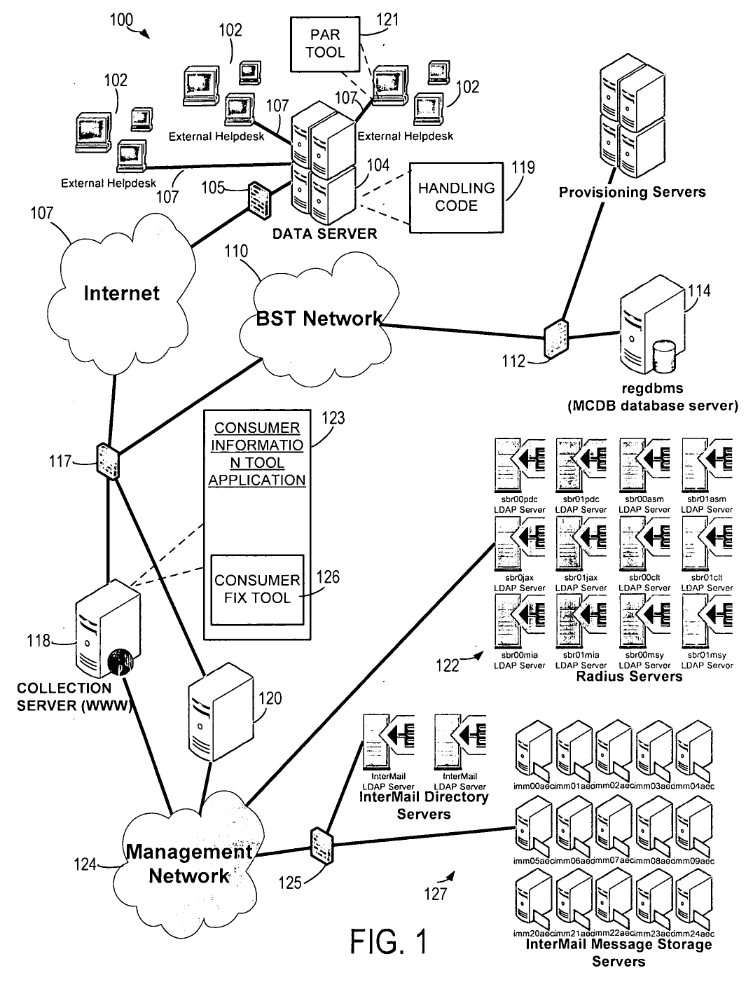

Referring now to the drawings, in which like numerals represent like elements through the several figures, aspects of the present invention and the illustrative operating environment will be described. FIGS. 1-3 and the following discussion are intended to provide a brief, general description of a suitable computing environment in which the embodiments of the invention may be implemented. While the invention will be described in the general context of program modules that execute in conjunction with a BIOS program that executes on a personal or server computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Aspects of the invention may be implemented as a computer process, a computing system, or as an article of manufacture such as a computer program product or computer-readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings. Referring now to FIG. 1, a schematic diagram illustrating aspects of a networked operating environment 100 utilized in an illustrative embodiment of the invention will be described. As shown in FIG. 1, the networked environment 100 includes help desk computers 102, utilized by agents and accessing data servers 104 such as from SupportSoft of Redwood City, Calif. Each help desk computer 102 represents an individual agent at a call center. The helpdesk computer 102 has a GUI generated by a problem analysis and resolution (PAR) tool application 121 that loads on to each helpdesk PC. The agent will key in a customer's information such as a digital subscriber line (DSL) telephone number or an e-mail address, and then select submit.

Next, the information is sent out to the data server 104 via a network 107, such as the Internet. The data server 104, utilizing handling code 119, takes all the information, compiles it in XML, and forwards the information to a collection server 118, such as a WWW server, through a firewall 117. The collection server 118 is where a customer information tool application (“CIT”) 123 resides. The CIT 123 takes the information from the data server 104, divides the information up and then queries every other system that needs to be queried. For example, the CIT 123 queries a master customer database (MCDB) 114 via a firewall 112, remote authentication dial-in user service (RADIUS) servers 122 for connectivity, mail servers 127 for mailbox information a management network 124, or a telecommunications network 110. The CIT 123 gets a response back to queries, individually, recompiles data back in the mail, forwards the data back to the data servers 104. The data servers 104 then parse that data and display the data via the GUI on the helpdesk computer 102.

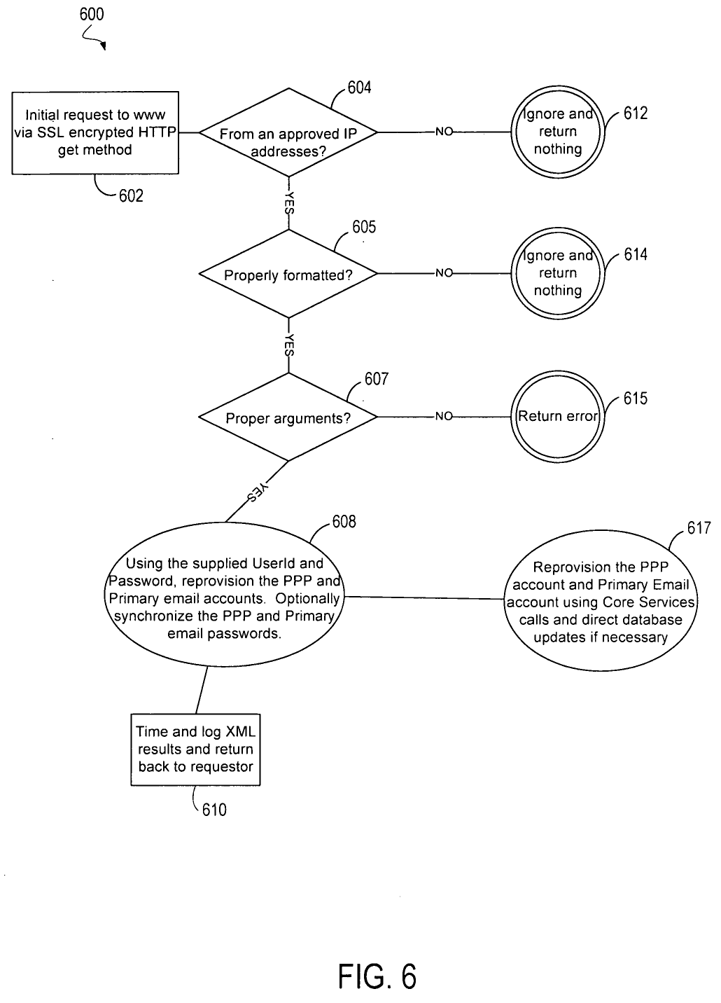

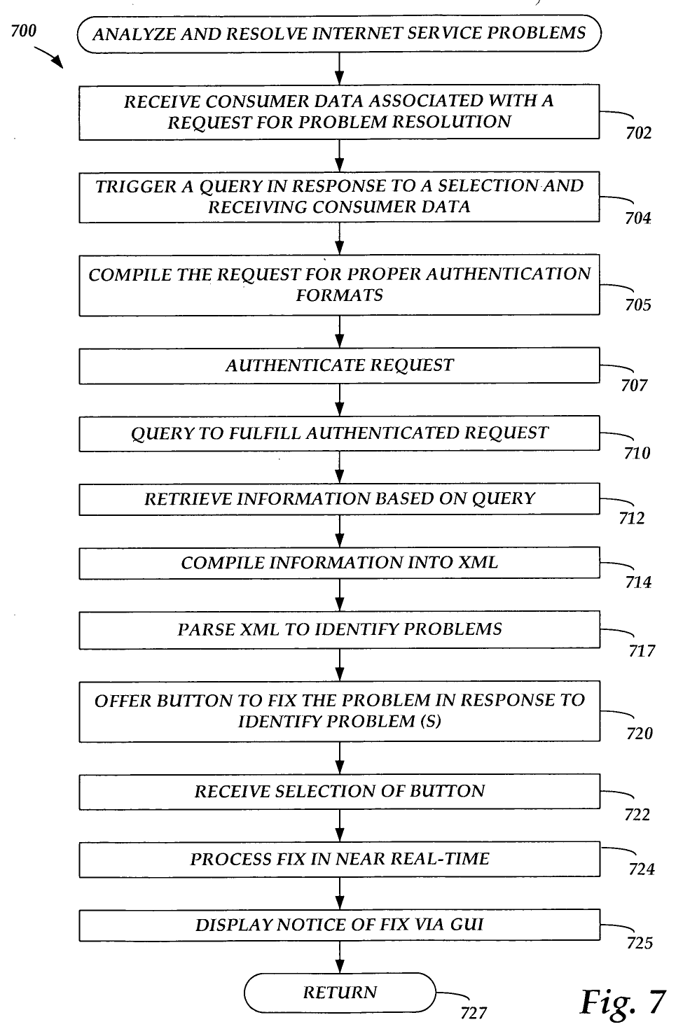

The collection server 118 is a web server, an FTP server, and does more than the CIT 123. It allows communications from those IP addresses with certain credentials. The CIT 123 handles communications with every individual system. The CIT 123 is a processing system that communicates to other systems that it is authorized to communicate with and returns information that agents need to know. The CIT 123 forwards the information to the data server 104. The data servers 104 and the helpdesk computers 102 form a type of front-end interface, namely the GUI in association with the handler of that GUI. The CIT 123 also includes a consumer fix tool (CFT) 126 that, when triggered by a fix command, actually communicates with a consumer provisioning server 120 to fix an identified problem. Additional details regarding the CFT 126 will be described below with respect to FIGS. 6 and 7.

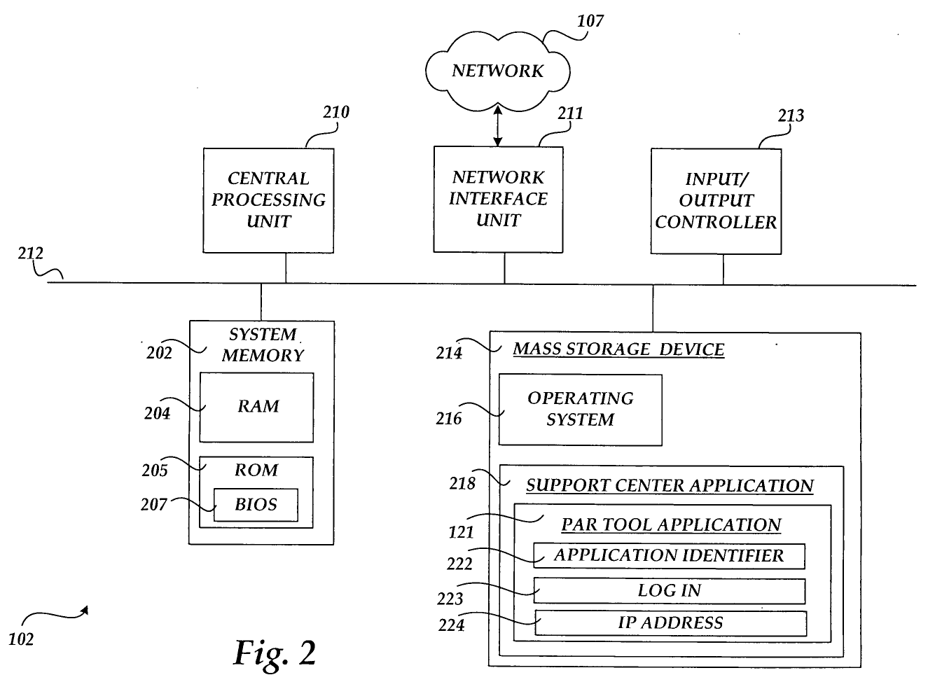

FIG. 2 illustrates computing system architecture for an external helpdesk PC 102 utilized in an illustrative embodiment of the invention. The helpdesk PC 102 includes a central processing unit (CPU) 210, a system memory 202, and a system bus 212 that couples the system memory 202 to the CPU 210. The system memory 202 includes read-only memory (ROM) 205 and random access memory (RAM) 204. A basic input/output system 207 (BIOS), containing the basic routines that help to transfer information between elements within the helpdesk PC 102, such as during start-up, is stored in ROM 205. The helpdesk PC 102 further includes memory such as the mass storage device (MSD) 214 for storing an operating system 216 such as WINDOWS XP, from MICROSOFT CORPORATION of Redmond, Wash. and the support center application 218 housing the PAR tool application 121. The support center application manages the PAR tool 121. The PAR tool 121 generates the GUI, which is essentially an enhanced browser with Internet connectivity. The handling code 119 accepts information or a data string from authorized IP addresses and from the PAR tool 121. The PAR tool 121 includes an application identifier 222, a login 223 in a data screen, along with an IP address 224. Only certain IP addresses are authorized with the application identifier 222 flag. Certain flags are attached to a data string.

It should be appreciated that the MSD 214 may be a redundant array of inexpensive discs (RAID) system for storing data. The MSD 214 is connected to the CPU 210 through a mass storage controller (not shown) connected to the system bus 212. The MSD 214 and its associated computer-readable media, provide non-volatile storage for the helpdesk PC 102. Although the description of computer-readable media contained herein refers to a MSD, such as a hard disk or RAID array, it should be appreciated by those skilled in the art that computer-readable media can be any available media that can be accessed by the CPU 210.

The CPU 210 may employ various operations, discussed in more detail below with reference to FIG. 7 to provide and utilize the signals propagated between the helpdesk PC 102 and data servers 104 (FIG. 1). The CPU 210 may store data to and access data from the MSD 214. Data is transferred to and received from the MSD 214 through the system bus 212. The CPU 210 may be a general-purpose computer processor. Furthermore, as mentioned below, the CPU 210, in addition to being a general-purpose programmable processor, may be firmware, hard-wired logic, analog circuitry, other special purpose circuitry, or any combination thereof.

According to various embodiments of the invention, the helpdesk PC 102 operates in a networked environment, as shown in FIG. 1, using logical connections to remote computing devices via network communication, such as an Intranet, or a local area network (LAN). The helpdesk PC 102 may connect to the network 107 via a network interface unit 211. It should be appreciated that the network interface unit 211 may also be utilized to connect to other types of networks and remote computer systems. The helpdesk PC 102 may also include an input/output controller 213 for receiving and processing input from a number of devices, including a keyboard or mouse (not shown). Similarly, an input/output controller 213 may provide output to a display screen, a printer, or other type of output device.

A computing system, such as the helpdesk PC 102, typically includes at least some form of computer-readable media. Computer readable media can be any available media that can be accessed by the helpdesk PC 102. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the helpdesk PC 102.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

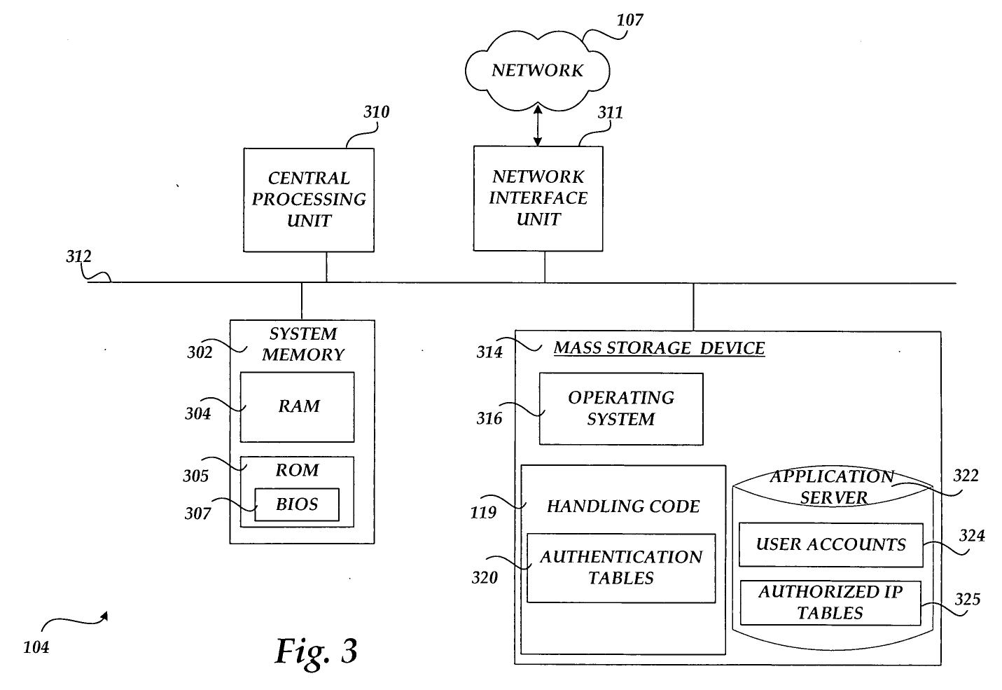

Similarly, FIG. 3 illustrates computing system architecture for the data server 104 utilized in an illustrative embodiment of the invention. The data server 104 is held at a data center, for example at an IBM Data Center. Thus, the communication between the PCs 102 and the PAR tool 121 is that over internal networking or a LAN at each individual helpdesk. Then the PAR tool 121 communicates over the public network over the Internet connecting to the data server 104. The data server 104 authenticates via several means: 1) the request data is coming from the support center application 218; 2) the sender is an authorized IP; and the data is encrypted. Once the data server 104 identifies the data as an authorized request, it processes that request, compiles it and then runs it through the firewall 117 because the data server 104 is authorized through the firewall 117.

The data server 104 includes a central processing unit (CPU) 310, a system memory 302, and a system bus 312 that couples the system memory 302 to the CPU 310. The system memory 302 includes read-only memory (ROM) 305 and random access memory (RAM) 304. A basic input/output system 307 (BIOS), containing the basic routines that help to transfer information between elements within the data server 104, such as during start-up, is stored in ROM 305. The data server 104 further includes memory such as MSD 314 for storing an operating system 316 and the handling code 119 housing authentication tables 320. An application server 322 also resides on the data server 104. The application server 322 is a type of database including user accounts 324 and authorized IP tables 325. The application server 322 processes and understands data strings and it processes data strings after validation for output into the collection server 118.

According to various embodiments of the invention, the data server 104 operates in a networked environment, as shown in FIG. 1, using logical connections to remote computing devices via network communication, such as an Intranet, or a local area network (LAN). The data server 104 may connect to the network 107 via a network interface unit 311. It should be appreciated that the network interface unit 311 may also be utilized to connect to other types of networks and remote computer systems.

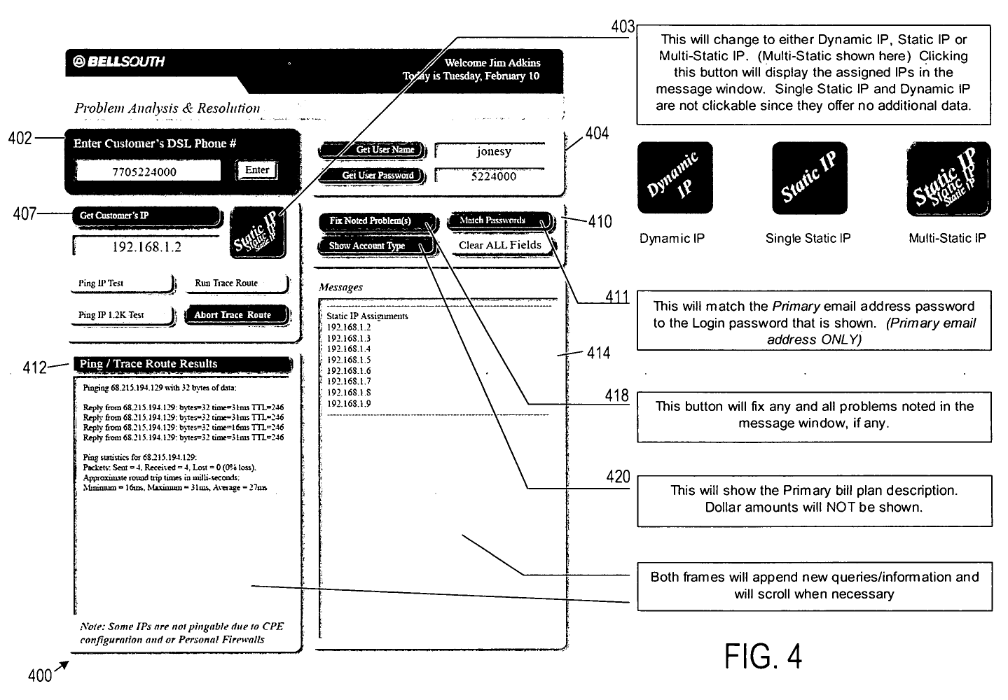

FIG. 4 illustrates an interface display (GUI) 400 utilized in an illustrative embodiment of the invention. The GUI 400 includes a variety of sections representing data input, data output, and command selection. A DSL number data entry section 402 is operative to receive a DSL number and trigger a query when the “ENTER” key is selected. A customer IP section 407 renders the IP address associated with a customer account. The IP address may be rendered when an IP button 403 is selected. The presence of the IP address in this section indicates the customer is connected to the Internet. Otherwise a notice identifying that the customer is not online will appear in a message frame 414. The IP button may be Static IP, Dynamic IP, or Multi-Static IP (Static-static). Static static means multi-static. The IP button 403 identifies the type of mailbox associated with a consumer or customer account. For example, every customer is one of three types: either they log on and get a new IP every time, Dynamic IP; they log on and get the same IP every time, Static IP; or a consumer is assigned a group of IPs for a network, Multi-Static IPs.

Similarly, a username/password section 404 renders both commands to retrieve the username and/or password and the username and password retrieved. For instance, a person may call and say, “I forgot my password.” The agent would have to reset it. It takes time to measure the servers and reset the password while the customer waits. With the use of the PAR tool 121, an agent can just tell the person the password. It should be appreciated that the GUI 400 will not display the password unless a password command button is selected. The password display is rendered on demand.

Still further, the GUI 400 includes a command section 410. The command section 410 includes a match password button 411, a fixed noted problem(s) button 418, and a show account type button 420. The match password button 410 when selected will initiate a match between a primary email address password and a login password that is shown. The fixed noted problem button 418 will fix any problems noted via the message frame 414. The fix noted problem(s) button 418 and the match passwords button 410 are grayed out when not applicable. In other words when the online connection is working fine the applicable fix and/or match buttons are grayed out thereby confirming that there is not a problem. The show account type button 420 will show the Primary bill plan description and provide the agent with the entire type of account. For instance, an account may include eight additional mailboxes or parental control features. These additional services would be listed out and the static IP via the GUI 400. Both frames 412 and 414 append new queries and/or information and scroll when necessary.

The PAR tool 121 is responsive substantially in real time, virtually instantaneous. A customer on a call for a very short time can now have an answer and a fix immediately. The analysis and fix are tied to the customer DSL number, e-mail and/or his or her customer account. Consumer data will tell the agent how to treat a consumer and configure their PC with a network. For instance, the GUI 400 can indicate whether the static IP is from a business, residential, or special/custom project, IP pool, such as Tinkerbell. Other capabilities of the GUI 400 include indicating whether the customer account is active, a hotline, or abuse restricted, indicating which if any email accounts associated with the consumer account are suspended or missing, and listing a consumer account name in an error message.

Additionally, other PAR tool 121 capabilities include rendering a DSL phone number associated with the consumer data while querying the systems to fulfill the request. The consumer data includes a username. Other capabilities of the PAR tool 121 include triggering a new query without clearing all fields of the GUI 400. Retrieving information associated with fulfilling the request includes comparing an IP address in one of the systems to a qualified IP (QIP). For example, certain ports are blocked for consumers but not for businesses. Thus, if a business is assigned a consumer IP, the agent will not understand certain failures without a QIP check.

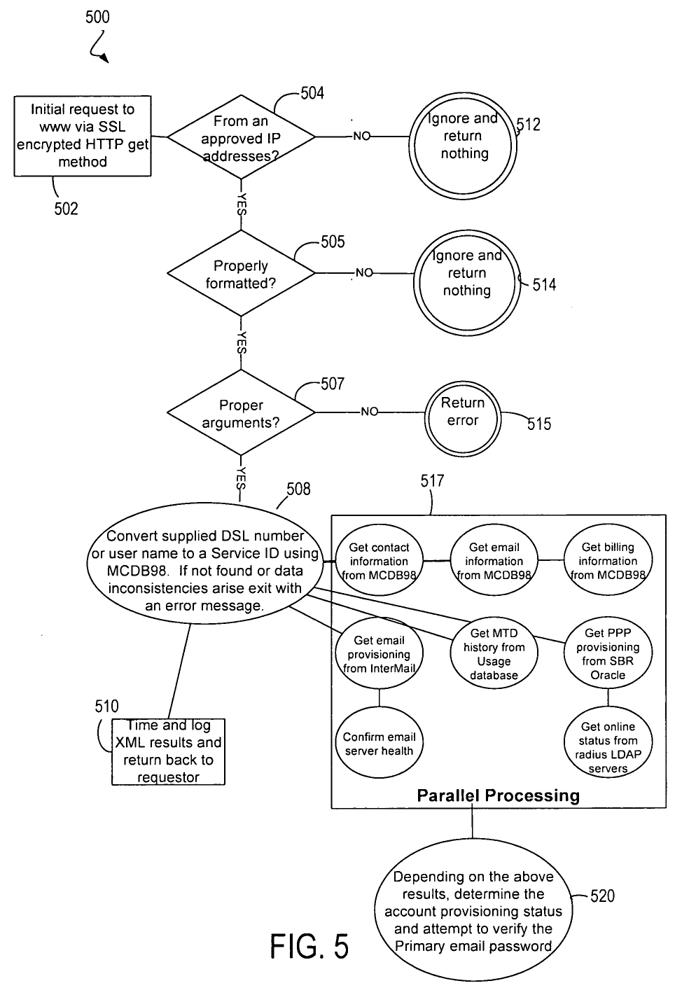

The PAR tool 121 may also render options for a desired packet size, receive a selection of desired packet size, and initiate a ping via a variety of packet sizes across multiple networks despite a location of the GUI 400 thereby identifying whether transmit units should be changed to clear a transmission path. Additional details regarding analyzing and resolving Internet service problems will be described below with respect to FIGS. 5-7.

Referring now to FIGS. 5-7, operational flows 500, 600, and 700 performed in analyzing and resolving an Internet service problem according to an illustrative embodiment of the invention, will be described. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIGS. 5-7, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

FIG. 5 illustrates an operational or logical flow 500 performed in analyzing an Internet service problem according to an illustrative embodiment of the invention. The logical flow 500 outlines the security implemented to approve an IP address properly formatted, proper arguments, and then to process a request. The logical flow 500 begins at operation 502, where the handling code 119 forwards a request to the collection server 118 via an SSL encrypted HTTP get method.

Next at operation 504, the CIT 123 determines whether the request is from an approved IP address. If not the logical flow 500 terminates at operation 512. If the request is from an approved IP address, the logical flow continues to operation 505. At operation 505 the CIT 123 determines whether the request is properly formatted. If not the logical flow 500 terminates at operation 514. If the request is properly formatted, the logical flow 500 continues to operation 507, where the CIT 123 determines whether the request includes proper arguments. If not, the CIT 123 returns an error at operation 515. When the argument is proper, the CIT 123 converts the supplied DSL number or username to a service identifier.

Once the CIT 123 authorizes the request, in parallel, the collection server 118 will retrieve the requested information from other systems at operation 517 and depending on the results, at operation 520 determine account provisioning and attempt to verify primary email password. At operation 510, the CIT 123 compiles the information in XML and forwards it back to the data server 104. When there is a query from the helpdesk computer 102 it goes through the handling code 119. The handling code 119 configures or compiles the query and hands off to the collection server 118 or CIT 123. The CIT 123 processes the information to obtain results, sends results back to the data server 104 and helpdesk computer GUI 400.

FIG. 6 illustrates an operational or logical flow 600 performed in resolving an Internet service problem according to an illustrative embodiment of the invention. When a problem is found while analyzing an Internet service problem according to logical flow 500, the GUI 400 renders and enables the fix noted problem button 418. For example, any customer email account may be improperly suspended or missing. When this happens an agent selects the fix button 418 on the GUI 400, which generates this fix process as illustrated in FIG. 6. The PAR tool 121 causes the GUI 400 to render what the problem is such as change this or reset this, or re-provision this. When the fix button is selected, the PAR tool 121 goes back to the data server 104 with a different command to actually correct the problem and gives the results message that the handling code 119 handed back to the helpdesk 102 and displayed on the GUI 400.

The logical flow 600 begins at operation 602 where the handling code 119 forwards a request to the collection server 118 via SSL encrypted HTTP get method. Next at operation 604, the CIT 123 determines whether the request is from an approved IP address. If not the logical flow 600 terminates at operation 612. If the request is from an approved IP address, the logical flow 600 continues to operation 605. At operation 605 the CIT 123 determines whether the request is properly formatted. If not the logical flow 600 terminates at operation 614. If the request is properly formatted, the logical flow 600 continues to operation 607, where the CIT 123 determines whether the request includes proper arguments. If not, the CIT 123 returns an error at operation 615. When the argument is proper, at operation 608, the CIT 123 re-provisions a point-to-point protocol (PPP) and primary email accounts using supplied userid and password. Optionally, the CIT 123 may synchronize the PPP and primary email passwords. When the match password button 411 is not available or active, this tells the agent that the PPP and primary email passwords match.

Once the CIT 123 authorizes the request, it may re-provision the PPP and the primary email account using core services calls and direct database updates if necessary at operation 617. At operation 610, the CIT 123 times and logs XML results and returns a notice of the fix back to the requestor.

The consumer-provisioning server 120, is a provisioning server that will go out and recreate the account when an account is missing improperly. So that is how it basically fixes problems, the consumer-provisioning server 120 will re-provision an account if it is missing or it will change the status of an account when it is improperly cancelled. Because the data server 104 now has the intelligence to ask for a particular type of fix, the CIT 123 has intelligence to trigger the fix through the consumer-provisioning server 120. It is automated and initiated from the customer or agent at the GUI 400.

The CIT 123 is really the same tool but the Consumer Fix Tool (CFT) 126 is a different module than the CIT 123. The CFT 126 is part of the CIT 123. Inside the collection server 118, a module within the CIT Application 123 is called the CFT 126. The CFT 126 both triggers an event and provides data.

FIG. 7 illustrates an operational flow 700 performed in analyzing and resolving Internet service problems according to an illustrative embodiment of the invention. The operational flow 700 begins at operation 702 where an agent is sitting in front of the GUI 400 and the GUI 400 has fields can be populated with titles of those fields. At operation 702, the PAR tool 121 receives via the GUI 400 consumer data associated with a request for Internet service problem analysis and resolution. Receiving consumer data associated with a request may include receiving any email address and/or any contact phone number associated with a consumer account.

Next, at operation 704, the PAR tool 121 triggers a query to retrieve additional data associated with the consumer data. Once the query is triggered, the handling code 119 compiles the request for proper authentication format at operation 705. Then at operation 707, the CIT 123 authenticates the request. At operation 710, the CIT 123 queries one or more systems to fulfill the request and at operation 712 retrieves from the systems, information associated with fulfilling the request. For instance, the CIT 123 will inform the agent the date the service became active, email account utilization showing a capacity for each mailbox, and display authentication information. The CIT 123 will also gather or display the previous speed tests that were run, the number of logins for a customer month to date, total online time for month-to-date, and the previous connection history. Additionally, the CIT 123 will determine and display the active or non-active status of other communications, multimedia, broadband, and narrow band services. The CIT 123 will also gather and display domain names owned by a given customer or consumer and display any pending DSL truck rolls or indicate there are none pending. A sample output in extensible markup language (XML) illustrating the CIT 123 capabilities is shown below.

At operation 714, the CIT 123 compiles the information retrieved into XML and forwards the information to the data server 104. Then, at operation 717, the data server 104 parses the XML to identify the Internet Service problem based on the information. At operation 720, the PAR tool 121 renders via the GUI 400 in real time the Internet service problem and renders a command or button to fix the problem. It should be appreciated that this command or button to fix the problem may be enabled or not grayed-out in response to identifying an Internet service problem.

Next at operation 722, the PAR tool 121 receives a selection of the command to fix the Internet service problem. At operation 724 in response to receiving the selection at operation 722, the CFT 126 triggers fixing the Internet service problem in substantially real time. If more than one problem was identified at operation 717, the CFT 126 will initiate a fix for all of them in one swoop. So, if the agent selects the fix command 418, it starts the fix tool process and sends a different formatted request back through the application server 104, down to the CIT 123. The CIT 123 then sees this different format, and processes a fix and sends a request to the provisioning server 120 to trigger the advance. The provisioning server 120 makes the corrections, sends back a statement providing notice of the fix. In the process, the CIT 123 takes the notice, formats it in XML, and sends it back up from the collection server 118 to the data server 104. The data server 104 parses that data, as in XML, and displays it on the GUI 400.

Once the problem has been fixed, the PAR tool 121 may disable the command to fix the Internet service problem. Then at operation 725, the PAR tool 121 displays notice of the fix via the GUI 400. The operational flow 700 then returns control to other operations at return operation 727. It should be appreciated that fixing the Internet service problem may involve configuring the command to communicate with CIT 123, authenticating the command with a formatted IP address, provisioning one or more fixes via one or more systems, and returning notice of the fixes to the CIT 123.

As briefly described above, a sample output in XML illustrating some CIT 123 capabilities is provided as follows:

```
    <?xml version=“1.0” encoding=“UTF-8” ?>
− <customer xmlns=“https://www.corp.bellsouth.net/customer”
      xmlns:xsi=“http://www.w3.org/2001/XMLSchema-instance”
      xsi:schemaLocation=“https://www.corp.bellsouth.net CIT.xsd”>
− <contact>
  <fullName>CLARA DOE</fullName>
− <address>
  <addressLine1>1268 HELEN ST</addressLine1>
  <city>Lake Land</city>
  <state>GA</state>
  <zip>30260</zip>
    </address>
− <phone>
  <HOM>4045122765</HOM>
  <DSL>4043777872</DSL>
    </phone>
− <authInfo>
  <authQuestion>What is your mother's maiden name?</authQuestion>
  <authAnswer>Mike</authAnswer>
    </authInfo>
    </contact>
− <email>
− <mailbox>
  <type>primary</type>
  <address>clara_doe</address>
  <status>active</status>
  <server>imm12aec</server>
  <serverStatus>ok</serverStatus>
  <TotalMessagesStored>36</TotalMessagesStored>
  <TotalBytesStored>1369223</TotalBytesStored>
  <MailboxSizeQuota-kb>256000</MailboxSizeQuota-kb>
  <MessageSizeQuota-kb>25600</MessageSizeQuota-kb>
  <MessageNumberQuota>2000</MessageNumberQuota>
  <MailboxPercentUsed>0.52</MailboxPercentUsed>
    </mailbox>
− <mailbox>
  <type>secondary</type>
  <address>ck3000</address>
  <status>active</status>
  <server>imm09aec</server>
  <serverStatus>ok</serverStatus>
  <TotalMessagesStored>0</TotalMessagesStored>
  <TotalBytesStored>0</TotalBytesStored>
  <MailboxSizeQuota-kb>256000</MailboxSizeQuota-kb>
  <MessageSizeQuota-kb>25600</MessageSizeQuota-kb>
  <MessageNumberQuota>2000</MessageNumberQuota>
  <MailboxPercentUsed>0</MailboxPercentUsed>
    </mailbox>
    </email>
− <billing>
  <startDate>12-17-2004</startDate>
  <serviceId>1008283997</serviceId>
− <primary>
  <planId>9014</planId>
  <planName>ADSL Res FastAccess</planName>
  <planDescription>$42.95 per month FastAccess service, includes 1 dial-up account, 1
      primary and 7 additional mailboxes, and 10MB Web space. Associated
      Mailboxes(alias): primary - clara_cook secondary - ck3000 Auth Question: What
      is your mother's maiden name? Auth Answer: Mike</planDescription>
    </primary>
− <secondary>
  <planId>4131</planId>
  <planName>Additional Mailbox</planName>
  <planDescription>Add a mailbox ($2.95 per box per month for each mailbox over the
      eight included with your account).</planDescription>
    </secondary>
− <secondary>
  <planId>4129</planId>
  <planName>FA DSL Svc Activation</planName>
  <planDescription>FastAccess Service Activation Charge</planDescription>
    </secondary>
    </billing>
− <ppp>
− <profile>
  <type>dynamic_ubr1536x256</type>
  <userName>clara_Doe</userName>
  <password>3665872</password>
  <mcdbServiceId>1008283997</mcdbServiceId>
  <dateCreated>2004-12-02 18:28:39.472</dateCreated>
  <dateModified>2004-12-02 18:28:39.62</dateModified>
    </profile>
− <profile>
  <type>dynamic_analog</type>
  <userName>clara_Doe</userName>
  <password>3665872</password>
  <mcdbServiceId>1008283997</mcdbServiceId>
  <dateCreated>2004-12-02 18:28:39.472</dateCreated>
  <dateModified>2004-12-02 18:28:39.62</dateModified>
    </profile>
− <onlineStatus>
  <radiusServer>sbr00asm</radiusServer>
  <device>65.14.248.38</device>
  <IPAddress>68.19.40.149</IPAddress>
  <pingable>YES</pingable>
  <startTime>12/13/2005 14:28:03</startTime>
    </onlineStatus>
    </ppp>
− <history>
  <MTDLogins>39</MTDLogins>
  <MTDTimeOnline>27:08:40:42</MTDTimeOnline>
− <past10connections>
− <connection>
  <date>12/13/2005</date>
  <time>14:26:11</time>
  <assignedIP>68.19.87.74</assignedIP>
  <duration>02:08:28:09</duration>
    </connection>
− <connection>
  <date>12/11/2005</date>
  <time>05:53:46</time>
  <assignedIP>68.215.233.91</assignedIP>
  <duration>01:10:26:13</duration>
    </connection>
− <connection>
  <date>12/09/2005</date>
  <time>19:25:00</time>
  <assignedIP>68.215.233.90</assignedIP>
  <duration>01:01:58:31</duration>
    </connection>
− <connection>
  <date>12/08/2005</date>
  <time>17:23:54</time>
  <assignedIP>68.219.250.228</assignedIP>
  <duration>03:18:04:33</duration>
    </connection>
− <connection>
  <date>12/04/2005</date>
  <time>23:18:51</time>
  <assignedIP>68.158.193.236</assignedIP>
  <duration>00:00:08:47</duration>
    </connection>
− <connection>
  <date>12/04/2005</date>
  <time>23:01:56</time>
  <assignedIP>68.19.92.34</assignedIP>
  <duration>00:00:03:20</duration>
    </connection>
− <connection>
  <date>12/04/2005</date>
  <time>22:55:49</time>
  <assignedIP>68.19.91.177</assignedIP>
  <duration>00:00:15:50</duration>
    </connection>
− <connection>
  <date>12/04/2005</date>
  <time>22:34:55</time>
  <assignedIP>68.219.250.99</assignedIP>
  <duration>00:00:11:03</duration>
    </connection>
− <connection>
  <date>12/04/2005</date>
  <time>22:23:21</time>
  <assignedIP>68.19.32.19</assignedIP>
  <duration>00:01:38:18</duration>
    </connection>
− <connection>
  <date>12/04/2005</date>
  <time>20:39:24</time>
  <assignedIP>68.211.70.219</assignedIP>
  <duration>00:03:19:48</duration>
    </connection>
    </past10connections>
    </history>
− <BSTAcctInfo>
  <btnNum>4043665872</btnNum>
  <addressName>CLARA DOE</addressName>
  <addressLine1>1229 HELEN ST</addressLine1>
  <addressLine2 />
  <addressCity>LK LD</addressCity>
  <usStateAbbr>GA</usStateAbbr>
  <addressZip>30260</addressZip>
  <number>4043665872197</number>
  <billAcctNum>4043665872197</billAcctNum>
  <status>OPEN</status>
  <type>RESIDENCE</type>
  <personalAcctAccessCode>0197</personalAcctAccessCode>
  <lastFourSSN>5201</lastFourSSN>
− <hotlineInfo>
− <BellSouth_Telephone>
  <status>OK</status>
    </BellSouth_Telephone>
− <BellSouth_Internet_Service>
  <status>OK</status>
    </BellSouth_Internet_Service>
− <Cingular_Wireless>
  <status>OK</status>
    </Cingular_Wireless>
− <BellSouth_Entertainment>
  <status>OK</status>
    </BellSouth_Entertainment>
− <BellSouth_Paging>
  <status>OK</status>
    </BellSouth_Paging>
− <BellSouth_Security_Systems>
  <status>OK</status>
    </BellSouth_Security_Systems>
    </hotlineInfo>
    </BSTAcctInfo>
− <abuseStatus>
  <status>OK</status>
    </abuseStatus>
− <speedTestResults>
  <error>FAILURE: No speed test results found</error>
    </speedTestResults>
− <dslDomains>
  <error>FAILURE: No domains located for clara_doe</error>
    </dslDomains>
− <dslAppointments>
− <item>
  <phoneNumber>4043665872</phoneNumber>
  <customerType />
  <apptId>3600379</apptId>
  <closeCode>Customer Surfing When Arrived</closeCode>
  <closeCategory>SUCCESSFUL</closeCategory>
  <id>3600379</id>
  <outCome>Customer Surfing When Arrived</outCome>
  <startTime>12/22/2004 08:00 AM</startTime>
  <endTime>2004-12-22 11:00:00.0</endTime>
  <duration>90</duration>
  <reason>2</reason>
  <slopBefore>0</slopBefore>
  <slopAfter>180</slopAfter>
  <orgId>710000</orgId>
  <orgName>BST Installation Master</orgName>
  <orgContact>888-701-2375</orgContact>
  <status>CLOS</status>
  <autoCancelTime />
  <contactPhone>4043665872</contactPhone>
  <name>CLARA DOE</name>
  <address1>1229 HELEN ST</address1>
  <address2 />
  <address3 />
  <city>LK LD</city>
  <state>GA</state>
  <zip>30260</zip>
  <zipPlus />
  <circuitId />
  <vpi />
  <vci />
  <rvpi />
  <rvci />
  <technology />
  <regCode />
  <cpeOrdered />
  <speedCode>4</speedCode>
  <atmMode>1</atmMode>
  <staticIPCount>0</staticIPCount>
  <warrantyExpires />
  <installerNote>((Repair)) Cust req early as possible</installerNote>
  <serviceType />
  <productType />
    </item>
    </dslAppointments>
− <accountProvisioning>
  <OKToFix>NO</OKToFix>
  <billing>ok</billing>
  <email>ok</email>
  <ppp>ok</ppp>
  <pppLogin>clara_doe</pppLogin>
  <pppPassword>3665872</pppPassword>
  <primaryEmailLogin>clara_doe</primaryEmailLogin>
  <primaryEmailPassword>3665872</primaryEmailPassword>
    </accountProvisioning>
  <elapsedTime>9.37</elapsedTime>
    </customer>
```

Thus, the present invention is presently embodied as methods, systems, computer program products or computer readable mediums encoding computer programs for analyzing and resolving Internet service problems.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-implemented method for analyzing and resolving an Internet service problem, the method comprising:
receiving via a user interface consumer data associated with a request for Internet service problem analysis and resolution;
triggering a query to retrieve additional data associated with the consumer data;
querying one or more systems to fulfill the request;
retrieving from the systems, information associated with fulfilling the request;
identifying the Internet Service problem based on the information; and
rendering in real time the Internet service problem via the user interface.

2. The method of claim 1, further comprising rendering via the user interface a command to fix the Internet service problem.

3. The method of claim 1, further comprising enabling the command to fix the Internet service problem in response to identifying the Internet service problem.

4. The method of claim 3, further comprising:
receiving a selection of the command to fix the Internet service problem;
in response to receiving the selection, fixing the Internet service problem in substantially real time; and
disabling the command to fix the Internet service problem in response to fixing the Internet service problem.

5. The method of claim 4, wherein fixing the Internet service problem comprises:
configuring the command to communicate with a customer information tool;
authenticating the command with a formatted IP address;
provisioning one or more fixes via one or more systems; and
returning notice of the fixes to the customer information tool.

6. The method of claim 5, further comprising:
formatting the notice of the fixes in XML;
parsing the notice; and
rendering the notice via the user interface in substantially real time.

7. The method of claim 1, wherein receiving consumer data associated with a request comprises receiving at least one of a primary email address or a DSL phone number.

8. The method of claim 1, wherein receiving consumer data associated with a request comprises receiving at least one of any email address or any contact phone number associated with a consumer account.

9. The method of claim 1, wherein identifying the Internet Service problem based on the information comprises:
authenticating the request;
compiling the information into a format; and
parsing the format to identify the Internet service problem.

10. The method of claim 1, further comprising:
rendering a type for a consumer account in response to triggering the query;
rendering a type of IP address designated for the type for the consumer account wherein the type of IP address designated comprises one of the following:
a dynamic IP comprising a new IP address for each login;
a static IP comprising a same IP address for each login; and
a multi-static IP comprising a static group of IP addresses.

11. The method of claim 10, further comprising indicating via the user interface whether the static IP is from a business, residential, or custom IP pool wherein the type for a consumer account comprises multiple mailboxes or parental control features.

12. The method of claim 10, further comprising:
indicating via the user interface whether the account is active, a hotline, or abuse restricted;
indicating via the user interface which if any email accounts associated with the consumer account are suspended or missing; and
listing a consumer account name in an error message.

13. The method of claim 1, further comprising:
rendering a DSL phone number associated with the consumer data while querying the systems to fulfill the request wherein the consumer data comprises a username; and
triggering a new query without clearing all fields of the user interface;
wherein retrieving information associated with fulfilling the request comprises comparing an IP address in one of the systems to a qualified IP (QIP).

14. The method of claim 1, further comprising:
rendering options for a desired packet size;
receiving a selection of desired packet size; and
initiating a ping via a variety of packet sizes across multiple networks despite a location of the user interface thereby identifying whether transmit units should be changed to clear a transmission path.

15. A computer program product comprising a computer-readable medium having control logic stored therein for causing a computer to analyze and resolve an Internet service problem, the control logic comprising computer-readable program code for causing the computer to:
receive via a user interface consumer data associated with a request for Internet service problem analysis and resolution;
trigger a query to retrieve additional data associated with the consumer data;
query one or more systems to fulfill the request;
retrieve from the systems, information associated with fulfilling the request;
identify the Internet Service problem based on the information; and
render in real time the Internet service problem via the user interface.

16. The computer program product of claim 15, further comprising computer-readable program code for causing the computer to render and enable via the user interface a command to fix the Internet service problem in response to identifying the Internet service problem.

17. The computer program product of claim 15, further comprising computer-readable program code for causing the computer to:
receive a selection of the command to fix the Internet service problem;
in response to receiving the selection, fix the Internet service problem in substantially real time; and
disable the command to fix the Internet service problem and render a notice of fixing the Internet service problem via the user interface in response to fixing the Internet service problem.

18. A computer-implemented system for analyzing and resolving Internet service problems, the system comprising:
one or more first computers operative to:
receive via a user interface consumer data associated with a request for Internet service problem analysis and resolution; and
trigger a query to retrieve additional data associated with the consumer data;
a first server computer operative to retrieve the additional data associated with the consumer data and forward the request to a second server computer;
the second server computer operative to:
authenticate the request;
query one or more other servers to fulfill the request;
retrieve from the other servers, information associated with fulfilling the request;
identify the Internet service problem based on the information; and
forward the Internet service problem to one of the first computers;
wherein at least one of the first computers renders in real time the Internet service problem via the user interface.

19. The system of claim 18, wherein the first computers are further operative to render and enable via the user interface a command to fix the Internet service problem in response to receiving the Internet service problem.

20. The system of claim 18, wherein the first computers are further operative to:
receive a selection of the command to fix the Internet service problem;
in response to receiving the selection, trigger a fix the Internet service problem in substantially real time;
receive a notice of fixing the problem; and
disable the command to fix the Internet service problem and render the notice via the user interface in response to fixing the Internet service problem.
